(19) United States
(12) Patent Application Publication
(10) Pub. No.: US 2013/0203581 A1
(43) Pub. Date: Aug. 8, 2013

(54) CENTRIFUGE INTEGRATING TACHOMETRIC DEVICE MOUNTED IN AN UPPER PART OF THE CHAMBER, ESPECIALLY MOUNTED ON THE LID

(71) Applicant: Jean-Louis Fondin, Saint Lyphard (FR)

(72) Inventors: Philippe Le Guyader, Poligne (FR); Jean-Louis Fondin, Saint Lyphard (FR); Franck Boucard, Challans (FR)

(73) Assignee: Awel International, Blain (FR)

(21) Appl. No.: 13/508,287

(22) PCT Filed: Nov. 4, 2010
(86) PCT No.: PCT/EP2010/066809

§ 371 Date: Dec. 17, 2012

(30) Foreign Application Priority Data
Nov. 4, 2009 (FR) 0905280

(51) Int. Cl. B04B 7/06

(52) U.S. Cl. CPC B04B 7/06
USPC 494/10

(57) ABSTRACT

A centrifuge is provided, which includes a chamber with a vessel in which are mounted a drive shaft for rotating a rotating assembly, and a measuring device for measuring the rotation speed of the rotating assembly. The chamber extends vertically between a bottom and an upper portion and includes a cover for opening/closing. The measuring device includes a transmitting portion rotated by the drive shaft and a second portion able to detect a passing frequency of the transmitting portion at a fixed point. The transmitting portion is supported by the rotating assembly and the second portion is mounted on the upper portion.

### CROSS-REFERENCE TO RELATED APPLICATIONS

This application is a Section 371 National Stage Application of International Application No. PCT/EP2010/066809, filed Nov. 4, 2010, which is incorporated by reference in its entirety and published as WO 2011/054901 on May 12, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the designing and manufacture of centrifugation equipment. More specifically, the disclosure pertains to centrifuges used in the fields of biology to centrifuge the products contained in receptacles placed in housings made in the rotor or carried by the rotor.

### BACKGROUND OF THE DISCLOSURE

Classically, the centrifuge comprises:
a drive shaft,
a rotor designed to be mounted removably on the drive shaft in a mounting position for which the drive shaft and the rotor are coupled in rotation,
a device for the axial locking of the rotor on the drive shaft, comprising a male element carried by the rotor, elastically stressed and capable of occupying a position of cooperation with a female element presented by the drive shaft.

Classically, centrifuges comprise a chamber including a vessel in which there is placed the rotor constituting the rotating element of the centrifuge.

Furthermore, a lid is mounted pivotally on the chamber about an axis extending towards the rear part of the lid, this lid being capable of pivoting between an open position giving access to the interior of the vessel and a closed position in which it hermetically closes the vessel.

In the closed position, the lid is maintained by locking means designed to hold the lid in the closed position throughout the centrifugation cycle.

Classically too, centrifuges incorporate tachometric means used to obtain the rotation speed of the rotating element constituted by the rotor. These pieces of data on rotation are essential to the working of the centrifuge, to achieve automatic feedback control over the rotation speed of the motor means as a function of the desired centrifugation cycle.

Referring to FIG. 1, a traditional technique used to obtain the rotation speed of the rotor consists in integrating tachometric means, generally constituted by an optical tachometer, at the bottom of the chamber of the centrifuge. In this technique, the disk D is fixedly joined in rotation to the motor of the centrifuge, this disk having a target reference and an optical reading means L capable of detecting the frequency of passage of the target reference so as to deduce therefrom a speed of rotation of the disk, enabling a subsequent check on the speed of rotation of the motor and indirectly, that of the rotating element.

This classic prior-art technique implies several drawbacks.

First of all, it is clearly necessary to provide for a space in the chamber of the centrifuge to integrate the tachometric means. Now this space, in practice, represents a non-negligible height which has an impact on the total height of the chamber and, therefore, that of the centrifuge.

However it is necessary, as far as possible, to restrict the height of a centrifuge. Indeed, centrifuges are most usually installed on desk tops of standard height and accessing the interior of the vessel of the centrifuge, in order to place samples in the vessel and remove these same samples from it, is done through the upper part of the centrifuge, after the opening of the lid. It can therefore be understood that the height of the centrifuge must be taken into account to enable an operator of average height to perform this handling operation with a certain degree of ease.

Another drawback of the prior-art technique lies in the accessibility of the tachometric means, whether it is at the time of their mounting, or that of their setting or maintenance.

Besides, in present-day centrifuges, the rotor is mounted removably on the drive shaft connected to the motor of the centrifuge.

These rotors undergo considerable stresses during each centrifugation cycle. They therefore have a limited service life, beyond which they show a risk of breakage and, if breakage occurs during a centrifugation cycle, the lead to major damage for the apparatus itself, and even for goods and individuals in the vicinity of the apparatus.

Thus, rotor manufacturers estimate the service life of centrifuges empirically, this service life being determined for an average number of cycles. It is therefore up to the operators to periodically check that this service life is not reached for a given rotor.

Naturally, such a practice is subject to interpretation or omission and can therefore lead to the use of a rotor which may become no longer viable.

Another problem related to the removable mounting of rotors on the drive shaft of the centrifuge lies in the reliability of the axial locking of the rotor on the drive shaft. Indeed, insufficient axial locking of the rotor on the drive shaft can, during the working of the centrifuge, give rise to a major risk of accident due to a fortuitous detachment of the rotor.

In practice the operator must carry out the mounting of the rotor on the drive shaft very attentively and with high precision in order to make sure that the axial locking is obtained with the greatest possible efficiency.

However, with present-day solutions, the operator is regularly subject to doubt as to the accurate mounting of the rotor on the drive shaft. Now, the operation of mounting the rotor on the drive shaft, inside the vessel of the centrifuge, can prove to be all the more difficult as accessing the interior of the vessel along its height is inconvenient.

### SUMMARY

An illustrative embodiment of the present disclosure relates to a centrifuge that facilitates the operations of installation of the rotor in the vessel of the centrifuge.

An embodiment of the invention proposes a centrifuge with height-wise space requirement that is restricted as compared with prior-art centrifuges.

An embodiment of the invention provides a centrifuge of this kind that is equipped with a tachometric device that is simple to install and easy to maintain.

An embodiment of the invention provides a centrifuge of this kind that offers an operator a guarantee of the efficient mounting of the rotor on the drive shaft.

An embodiment of the invention to propose a centrifuge that offers an operator guarantees as regards the efficient use of a rotor relatively to its service life.

Thus an embodiment of the invention proposes a novel approach to the mounting and integration of a tachometric device, according to which the tachometric device is mounted no longer at the bottom of the chamber as is the case with the prior-art solutions but at the upper part of the chamber of the centrifuge.

This approach thus averts the need to raise the motor unit relatively to the bottom of the chamber: this is necessary in the traditional techniques in order to make sufficient space to contain the disk coupled to the motor shaft and the optical reader coupled between this disk and the bottom of the chamber.

According to an embodiment of the invention, the rotor is used directly as a support of the target element of the tachometric device. This averts the need to add on and “stack” a rotating element (the disk) which makes it necessary to set aside a height-wise space in the chamber.

With the layout proposed by an embodiment of the invention, it is therefore possible to improve the height-wise compactness of the centrifuge which results in a reduction of about 30 to 40 mm in the height of the centrifuge.

Furthermore, the placing of the tachometric device at the upper part of the chamber facilitates their installation and their maintenance as compared with positioning them at the bottom of the centrifuge chamber.

According to a preferred embodiment, said second part is mounted on said lid.

Such an embodiment proves to be particularly advantageous. Indeed, the second part, constituting the part for “reading” the frequency of passage of the “sender” part carried by the rotor, can thus be brought into a collapsed position corresponding to the open position of the lid. In other words, the height-wise space that has to be reserved for this second part of the tachometric device is included in the thickness of the lid which, when it is in the open position, has no impact, height-wise, on the accessibility to the vessel of the centrifuge.

According to another characteristic, said rotating assembly carries a data storage device for storing data relative to its operation history.

Thus, it is possible to obtain precise data on the number of cycles performed by the rotor and therefore to obtain traceability on the use of this rotor, in order to detect whether or not the rotor has achieved the maximum number of cycles defined by the manufacturer.

In this case, said chamber advantageously carries a reader for reading said data storage device carried by said rotating assembly.

It is thus possible to program the centrifuge in such a way that this centrifuge, having been parameterized with data on the maximum number of cycles for a rotor, prohibits the launching of a centrifugation cycle if this maximum number of cycles has been achieved for a given rotor.

Preferably, said chamber carries a sending device configured to send data to be recorded by said data storage device.

Thus, the operation history recorded in the storage device of the rotor get automatically incremented with the operating data given by the centrifuge itself.

According to a preferred embodiment, said sending device is capable of contactless sending of data to be recorded by said storage device.

Advantageously, said lid carries a sender/receiver device capable of cooperating with said storage device carried by said rotor. According to the principle of an embodiment of the invention, these storage device is constituted by the RFID chip carried by the rotor.

According to an advantageous solution, said chip preferably occupies a central position on said rotor.

Such a central position of the RFID chip on the rotor limits the effects of the centrifugal force (which are extremely great during a centrifugation cycle) on the RFID chip, thus preserving it from a mechanical as well as an electronic point of view.

According to yet another advantageous characteristic of an embodiment of the invention, the centrifuge comprises a device for the axial locking of a rotating assembly on a drive shaft connected to said motor, said locking device comprising at least one male element carried by said rotating assembly and capable of occupying a position of cooperation with a female element presented by said drive shaft, and furthermore comprising a detecting device configured for detecting the axial positioning of the rotor on said drive shaft in a position corresponding to said position of cooperation of said male element with said female element.

In this way, the operator has available assistance in checking the accurate mounting of the rotor on the drive shaft.

In this case, said rotating assembly carries a target element and said chamber carries a an indentifying device configured for identifying said target element.

Preferably, said identifying device is carried by said lid.

It can be noted that a centrifuge according to an embodiment of the invention is thus characterized generally by the implementation of a “smart technique” lid in as much as it constitutes no longer a simple opening/closing element but a unit capable of performing complex functions related especially to:
measuring the rotation speed of the rotating assembly;
detecting the current location in height of the rotor on the drive shaft;
exchanging data on the operation history of the rotor.

According to yet another advantageous characteristic of an embodiment of the invention, said vessel has, at its base, a concavity in which an upper part of the motor gets housed.

Such a layout gives an additional reduction in height of the centrifuge, of the order of 15 to 20 mm.

### BRIEF DESCRIPTION OF THE DRAWINGS

Other features and advantages shall appear more clearly from the following description of an embodiment of the invention given by way of an illustratory and non-exhaustive example and from the appended drawings of which:

FIG. 1 is a schematic representation of a centrifuge according to the prior art;

FIGS. 2 and 3 are overall views of a centrifuge according to an embodiment of the invention respectively with and without the rotor;

FIG. 4 is a view in section of a centrifuge according to an embodiment of the invention;

FIG. 5 is a detailed view of FIG. 4;

FIG. 6 is a partial view of the lid and of the axial locking device for the axial locking the rotor to the drive shaft of a centrifuge according to an embodiment of the invention;

FIG. 7 is another partial view of the lid and of the locking device for the axial locking of the rotor to the drive shaft of a centrifuge according to an embodiment of the invention;

FIGS. 8 and 9 are top views of the locking device for the axial locking of the rotor to the drive shaft of a centrifuge according to an embodiment of the invention, respectively in the locked position and in the unlocked position;

FIGS. 10 and 11 illustrate curves of signals detected by tachometric device of a centrifuge according to an embodiment of the invention, respectively in the locked position and in the unlocked position of the locking device for the axial locking of the rotor to the driveshaft.

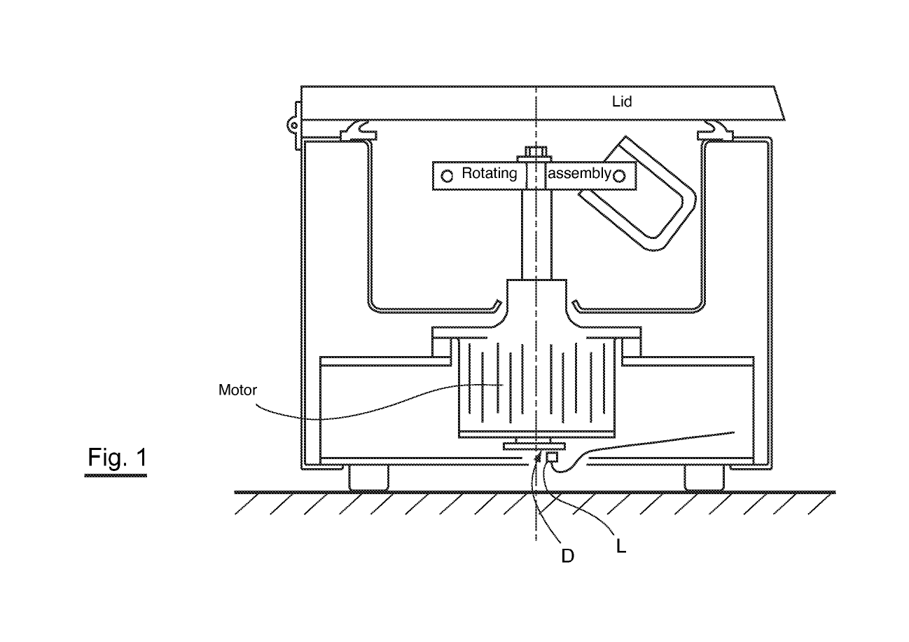

### DETAILED DESCRIPTION OF ILLUSTRATIVE EMBODIMENTS

As indicated here above, the principle of an embodiment of the invention lies in the fact of proposing a centrifuge in which the measuring device used to measure the speed of rotation of the rotor are mounted at the upper part of the chamber of the centrifuge. Furthermore, the implementation of an RFID chip mounted on the rotor makes it possible to store and exploit data pertaining especially to the operation history of the rotor.

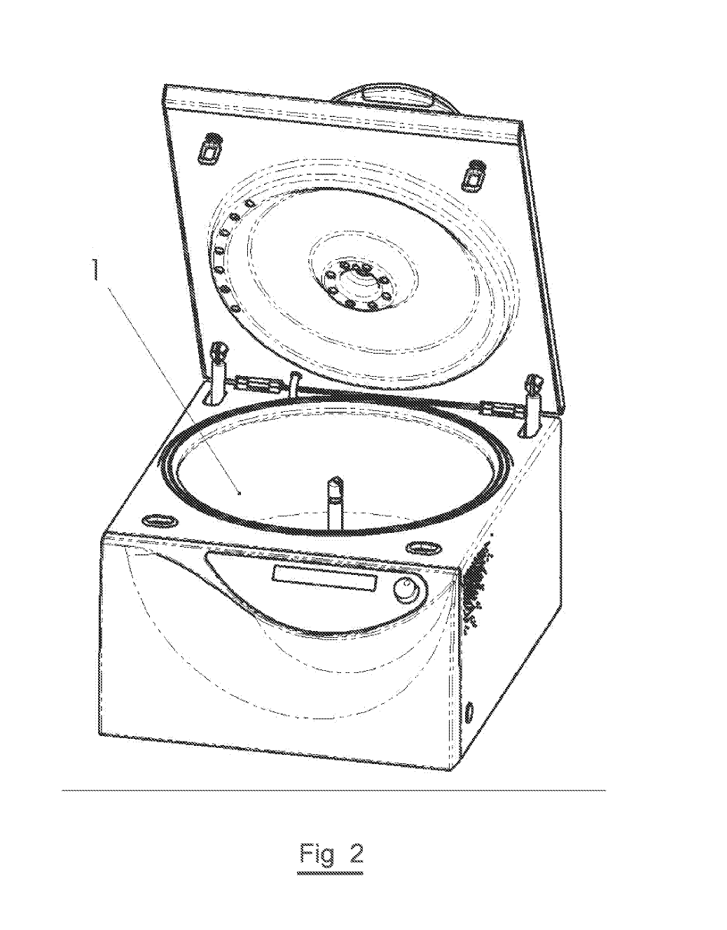

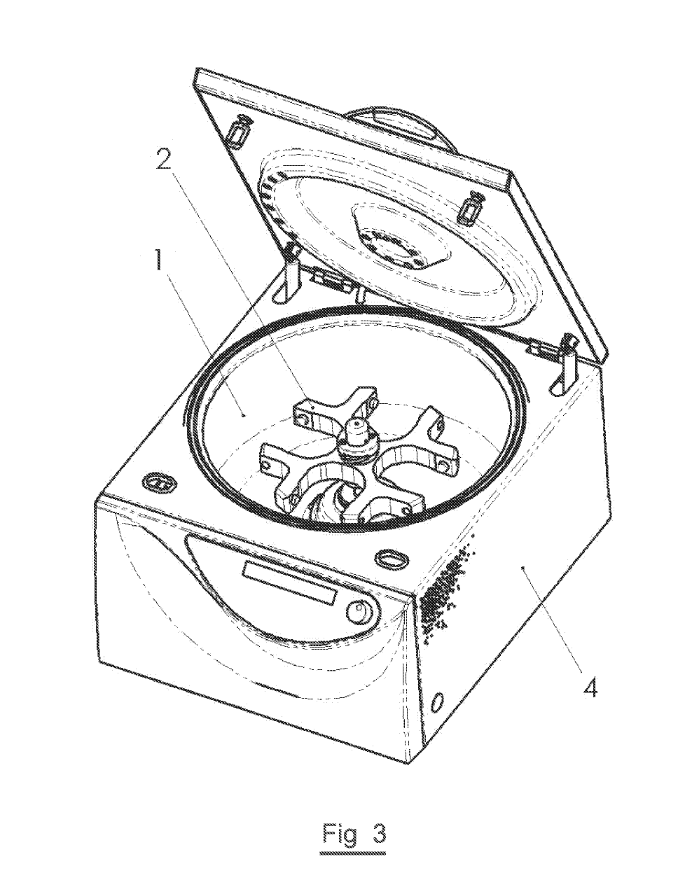

Referring to FIGS. 2 to 4, a centrifuge according to an embodiment of the invention, in a classic manner known per se, comprises a vessel 1 incorporating:
a motor unit 100 connected to a drive shaft 101;
a rotor 2 mounted removably on the drive shaft 101, in a mounting position for which the drive shaft and the rotor are rotationally coupled;
a device 3 providing for an axial locking of the rotor to the drive shaft.

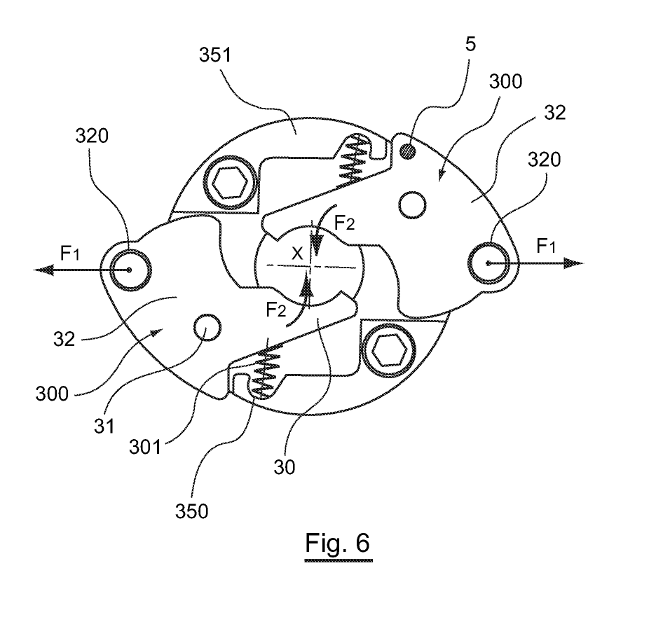

According to the present embodiment, the axial locking of the rotor to the drive shaft is obtained by the implementing of:
an annular groove 1010 made on the drive shaft, constituting a female element presented by the drive shaft;
a pair of male elements 300 (FIG. 6) carried by the rotor and capable of occupying a position of cooperation with the annular groove 1010 in being engaged with it under the action of an elastic stress.

As can be seen in FIG. 6, the device 3 comprises a pair of male elements 300 each mounted pivotally about a pivoting pin 31 parallel to the axis X of the drive shaft, the pivoting pin 31 of each male element being mounted on a ring 35 embedded in a housing 20 prepared on the upper part of the rotor 2.

The male elements 300 are mounted so as to be diametrically opposite to each other relatively to the axis X on the ring 35. The same is therefore the case for the diametrically opposite positions of the pivoting pins 31.

Furthermore, each male element 300 is elastically stressed by a spring 301, one end of which takes support on a male element while the other end is housed in a cavity 350 of the ring 35, this spring 301 being designed and mounted so as to act in compression in such a way that each spring 301 tends to make the corresponding male element pivot towards its position of cooperation with the annular groove 1010 of the drive shaft 101.

More specifically, each male element 300 comprises:
an engaging termination 30 extending on one side of the pivoting pin 31 and against which the spring 301 takes support, this engaging termination 30 being designed to get engaged in the annular groove 10 of the drive shaft to ensure the axial locking of the rotor on the drive shaft;
an ear-shaped attachment 32 extending on the other side of the pivoting pin relatively to the engaging termination, this ear-shaped attachment constituting a visual and/or tactile indicator as explained here below.

It can be noted that the angular play of the engaging termination 30 of each male element 300, in the direction along which the termination is off-centered relatively to the axis X, is limited by a shoulder 351 made on the ring 35.

At the same time, the diametrically opposite shoulders 351 mutually make a space in which the ear-shaped attachments 32 extend, this space between the shoulders being also designed to enable an angular play of the ear-shaped attachments 32.

Furthermore, the rotor 2 has an annular cage 33 designed to be attached and fixed to the ring 35, this annular cage 33 demarcating a volume forming a housing for the male elements 300.

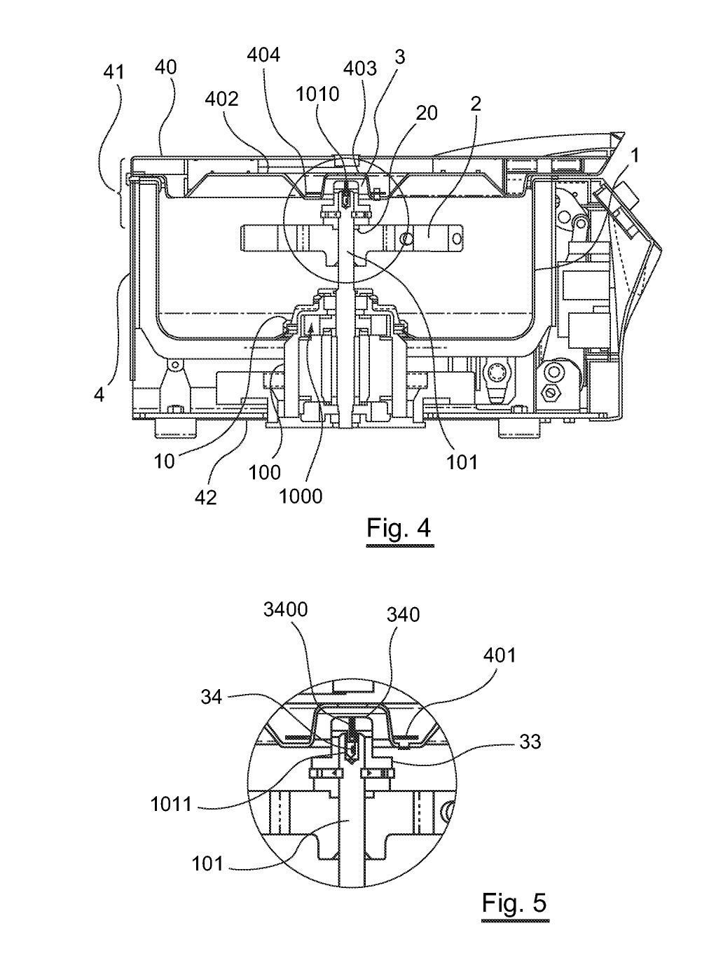

Furthermore, the annular cage 33 is provided with a radial passage 330 for each ear-shaped attachment 32. These radial passages 330 and the sizing of the diameter of the annular cage 33 are designed so as to permit two positions for the visual and/or tactile indicator formed by the ear-shaped attachments 32, namely:
a position of concealment in which the ear-shaped attachments are housed integrally within the annular cage, the ear-shaped attachments being therefore neither visible nor accessible to touch (or almost non-accessible to touch) in this position (FIG. 9);
a position for indicating the axial locking of the rotor on the drive shaft in which the ear-shaped attachments protrude through the passages 330 of the annular cage 33, the ear-shaped attachments being then presented outside the annular cage so as to be visible and accessible to being touched (as can be seen in FIGS. 4 and 6).

To further increase the visible nature of the ear-shaped attachments when they are made to protrude through the radial passages 330 of the annular cage, a color indicator 320 (for example green) is attached to the upper face of each ear-shaped attachment 32.

To mount the rotor on the drive shaft, the operator engages the rotor on the drive shaft until the male elements 300 reach the annular groove 1010 of the driveshaft. At this stage, under the effect of the springs 301, the engaging terminations 30 penetrate the annular groove of the drive shaft. This simple fact of placing the position of the male elements in axial correspondence with the location of the annular groove of the drive shaft is enough to cause the male elements to pivot about their pivoting pin as indicated by the arrow F2 in FIG. 6.

Besides, the centrifuge comprises:
a chamber 4 demarcating a volume into which the vessel 1 is integrated;
a lid 40 mounted pivotally about an axis extending towards the rear of the lid, this lid being moveable between an open position (FIG. 2) enabling access to the vessel 1 and a closed position (FIG. 4).

The chamber 4 of the centrifuge extends vertically between a bottom 42 and an upper part 41 including the lid 40, this upper part also including therefore the pivoting pin of the lid.

Furthermore, according to the principle of an embodiment of the invention, the centrifuge also has a speed measuring device to measure the speed of rotation of the centrifuge, the device comprising:
a first part called an sender carried by the rotor 2;
a second part capable of detecting a frequency of passage of the sender part at a fixed point, this second part being mounted on the upper part 41 preferably on the lid 40 of the centrifuge.

These first and second parts constitute a tachometric device, or tachometer, by which it is possible to obtain the rotation speed of the rotating assembly constituted by the rotor.

According to the present embodiment, the sender part carried by the rotor is formed by the indicators 320, each of them being a magnet. At the same time, the second part capable of detecting a frequency of passage of the sender part is a radio-magnetic effect sensor 3200 carried by the lid (this sensor being therefore at a fixed point of the centrifuge once the lid is closed).

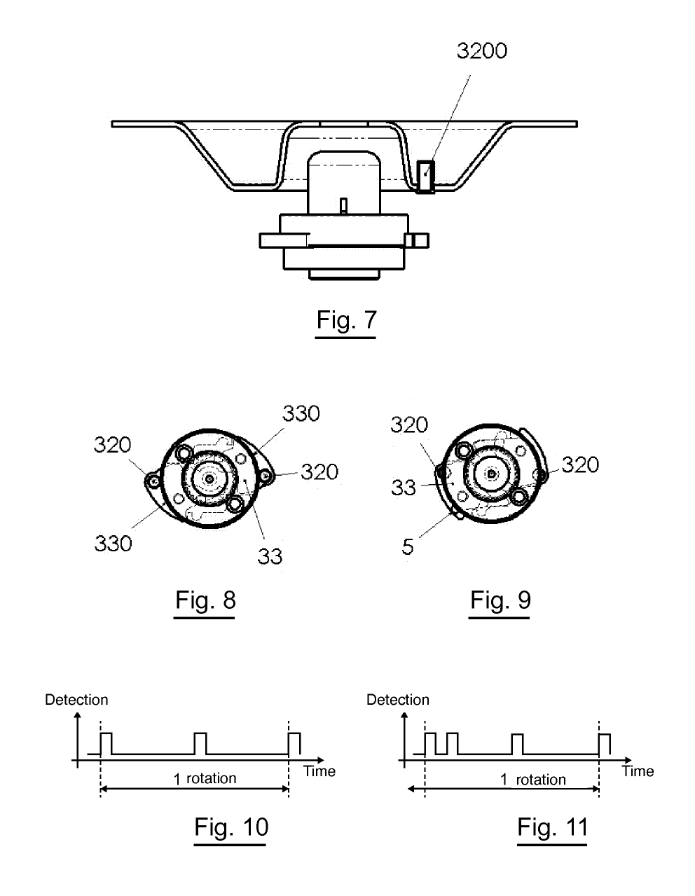

Furthermore, according to another aspect of an embodiment of the invention illustrated by FIGS. 6 to 10, one of the male elements 300 of the axial locking device 3 has a target element 321 while the chamber, and preferably the lid according to the present embodiment, carries a locating device configured for locating the target element 321, this assembly being designed to form a detecting device configured to detect the axial positioning of the rotor on the drive shaft in the position corresponding to the position of cooperation of said male element with the annular groove 10 of the drive shaft 1.

This target element is formed according to the present embodiment by a magnet mounted at one corresponding end of the ear-shaped attachment 32 opposite the end receiving the indicator 320 relatively to the pivoting pin 31. It can be noted that, according to this device, when the axial locking device is in an unlocked position, the magnet 321 is presented outside the annular cage 33 (FIG. 9) while, inversely, when the axial locking device is in the locked position, the magnet 5 is concealed within the annular cage 33 (FIG. 8).

Thus, when the rotor rotates and when the axial locking device is in a locked position (FIG. 8), the radio-magnetic effect sensor 3200 will send a signal corresponding to a curve of the type shown in FIG. 10: two signals evenly spaced out corresponding to the passages of the indicators 320 beneath the radio-magnetic effect sensor 3200.

By contrast, when the rotor rotates and the locking device is not in a locked position (FIG. 9), the radio-magnetic effect sensor 3200 will send a signal corresponding to the curve of the type shown in FIG. 11: three signals corresponding to the passages of the indicator 320 and that of the magnet 5 beneath the radio-magnetic effect sensor 3200, these signals being spaced out unevenly in sets of two (the magnet 321 being closer to one of the indicators 320 than to the other). In this case, the curve is interpreted as representing an unlocked position of the rotor on the drive shaft and the centrifugation cycle is immediately stopped.

Besides, the rotational coupling of the rotor with the drive shaft comprises:
firstly, a diametral slot 1011 extending from the upper end of the drive shaft 101;
a diametral rod fixed to the rotor, designed to get housed in a diametral slot 1011 of the drive shaft to provide for the rotational coupling of the rotor with the drive shaft.

At the same time, the rotor 2 carries an annular cage 33 designed to be attached to and fixed on the base 35, this annular cage 33 demarcating a volume forming a housing for the male elements 300.

The diametral rod 34 is mounted by force into a cap 340 overhanging the annular cage 33.

According to the principle of an embodiment of the invention, an RFID chip 3400, carried by the rotor, is mounted within the cap 340, this chip extending according to the present embodiment along the axis of this cap, so as to occupy a central position on the rotor.

This RFID chip constitutes a data storage device for storing data on the operation history of the rotor. The upper part of the chamber, and more specifically the lid according to the present embodiment, has a sender/receiver device 401 designed to cooperate with the RFID chip carried by the rotor.

The sender/receiver device thus constitutes a reader (for the receiver part) for reading data stored by the RFID chip and means for sending data to be recorded by the RFID chip.

Besides, the sender/receiver device 401 enables contactless cooperation with the RFID chip, for the exchange of data with this chip.

Naturally, the centrifuge incorporates a processor device configured to execute a program to:
store data on the maximum number of cycles that a type of rotor can execute without risk;
translate parameters of centrifugation cycles into the form of data to be sent to the RFID chip of the rotor and stored by it;
receive data stored by the RFID chip, process this data and compare it with data on the maximum number of cycles for a given rotor so as to prohibit the launching of a centrifugation cycle if the data stored by the RFID chip pertaining to the operation history indicates that this maximum number has been reached.

It can be noted that the internal face 402 of the lid 40 has a concavity 403 at its center designed to form a housing into which the cap 340 of the rotor gets contained in the closed position of the lid.

Furthermore, this concavity 403 is surrounded by an annular zone 404 into which the sender/receiver device 401 is mounted.

Besides, it can be noted that the vessel 1 has a concavity 10 at its base in which an upper part 1000 of the motor 100 get housed.

The chamber of the centrifuge furthermore incorporates a dampener associated with the drive elements.

1. A centrifuge comprising:
a chamber including a vessel, said chamber extending vertically between a bottom and an upper part of the chamber and including an opening/closing lid;
a motor mounted in the chamber, under the vessel and configured to rotationally drive a rotating assembly; and
a speed measuring device configured to measure speed of rotation of said rotating assembly, said speed measuring device comprising a part called a sender part rotationally driven by said motor and a second part capable of detecting a frequency of passage of said sender part at a fixed point, wherein said sender part is carried by said rotating assembly and said second part is mounted on said upper part, said rotating assembly carrying an RFID chip and said chamber carrying a sender/receiver capable of cooperating with said RFID chip.

2. The centrifuge according to claim 1, wherein said second part is mounted on said lid.

3. The centrifuge according to claim 1, wherein said rotating assembly carries a data storage device for storing data relative to its operation history.

4. The centrifuge according to claim 3, wherein said chamber carries a device configured to read said data storage device carried by said rotating assembly.

5. The centrifuge according to claim 3, wherein said chamber carries a sending device configured to send data to be recorded by said data storage device.

6. The centrifuge according to claim 5, wherein said sending device is capable of contactless sending of data to be recorded by said data storage device.

7. The centrifuge according to claim 3, wherein said lid carries the sender/receiver capable of cooperating with said data storage device carried by said rotating assembly.

8. The centrifuge according to claim 1, wherein said chip occupies a central position on said rotating assembly.

9. The centrifuge according to claim 1, comprising a locking device for axial locking of said rotating assembly on a drive shaft connected to said motor, said locking device comprising at least one male element carried by said rotating assembly and capable of occupying a position of cooperation with a female element presented by said drive shaft, and wherein the centrifuge comprises a detector configured to detect the axial positioning of the rotor on said drive shaft in a position corresponding to said position of cooperation of said male element with said female element.

10. The centrifuge according to claim 9, wherein said rotating assembly carries a target element and said chamber carries a an identifying device configured to identify said target element.

11. The centrifuge according to claim 10, wherein said identifying device is carried by said lid.

12. The centrifuge according to claim 1, wherein said vessel has, at its base, a concavity in which an upper part of the motor gets housed.
